(19) United States
(12) Patent Application Publication
(10) Pub. No.: US 2012/0200659 A1
(43) Pub. Date: Aug. 9, 2012

(54) Displaying Unseen Participants in a Videoconference

(76) Inventor: Wayne E. Mock, Round Rock, TX (US)

(21) Appl. No.: 13/020,532

(22) Filed: Feb. 3, 2011

(51) Int. Cl. H04N 7/15

(52) U.S. Cl. 348/14.08; 348/E07.083

(57) ABSTRACT

Displaying unseen participants in a videoconference. A videoconference layout including a plurality of portions may be displayed on a display. Each portion of the videoconference layout may include one or more participants of the videoconference. Additionally, a plurality of the participants of the videoconference are not currently displayed in the videoconference layout. User input may be received to view the plurality of the participants who are not currently displayed in the videoconference layout. Accordingly, in response to the user input, the plurality of the participants may be displayed in a first portion of the videoconference layout.

### FIELD OF THE INVENTION

The present invention relates generally to conferencing and, more specifically, to displaying unseen participants in a videoconference.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to one or more other (remote) participants. Each videoconferencing system may also include a display and speaker to reproduce video and audio received from remote participant(s).

During a videoconference each participant may view one or more other participants in a videoconference. However, in some videoconferencing layouts, the participant may not be able to view every participant in the videoconference. Accordingly, improvements in videoconferences are desired.

### SUMMARY OF THE INVENTION

Various embodiments are presented of a system and method for displaying unseen participants in a videoconference.

Initially, a videoconference may be established among a plurality of videoconferencing endpoints. Each videoconferencing endpoint may provide videoconferencing capabilities for one or more participants of the videoconference. Thus, the videoconference may be established for a plurality of participants.

During the videoconference, each videoconferencing endpoint may provide a videoconference layout on a display of the videoconferencing endpoint. The videoconference layout may include a plurality of different portions. Each portion of the videoconference layout may include one or more participants of the videoconference (e.g., at a respective other videoconference location). Thus, the videoconference layout may display a first subset of the plurality of participants. However, the videoconference layout may not include a second subset of the plurality of participants. Thus, a first participant at a first location may only view the first subset of participants in the videoconference layout, but may not be able to view the second subset of participants in the videoconference layout. As an example, the number of participants in the videoconference may be too large to all fit in the layout, and hence only a subset (first subset) of the participants may be displayed.

Accordingly, user input to view the second subset of the plurality of participants may be received from the first participant. In response to the user input, the second subset may be displayed in a first portion (e.g., a predetermined portion) of the videoconference layout. For example, different groups of one or more participants of the second subset may be temporarily displayed in the first portion of the layout over a plurality of iterations. Thus, at a first time (e.g., in a first iteration), a first group (e.g., one or more) of the second subset of participants may be displayed in the first portion. At a second time, a second group of the second subset of participants may be displayed in the first portion, and so on.

Separate user input may be received for displaying each of the different groups. For example, the separate user input may be provided at each iteration to change from one group to the next. Alternatively, each different group may be displayed automatically without user input to change each displayed group. For example, the groups may be displayed periodically, e.g., on a timed interval (e.g., every 1 second, 2 seconds, 5 seconds, 10 seconds, etc.). Thus, in this latter embodiment, the user may select an option to display unseen participants, and the videoconference system may automatically “cycle through” display of the unseen participants at a timed interval on a predetermined portion of the display.

The first portion of the videoconference layout may be a least prominent portion of the videoconference layout. For example, the least prominent portion may be a smaller portion of the videoconference layout. As another example, the least prominent portion may be in a corner of the videoconference layout (e.g., a top left or right corner). In some embodiments, the videoconference layout may have an “active speaker portion” and a “continuous presence portion”. The active speaker portion may be used to display a current active speaker or prominent participant in the videoconference. The continuous presence portion may include one or more subportions where other participants are shown. In layouts including these two types of portions, the least prominent portion may be in the continuous presence portion (e.g., in one of the subportions of the continuous presence portion). In one embodiment, a participant in a subportion of the continuous presence portion may be promoted to the active speaker portion. Accordingly, in embodiments where that subportion is no longer used, it may be used for displaying the unseen participants of the videoconference. Thus, that vacated subportion may be the “least prominent portion” of the videoconference layout. In another embodiment, the “least prominent portion” of the videoconference layout may be the portion of the videoconference that is used for a participant who is currently being displayed but has spoken the least in the videoconference (e.g., over the whole of the videoconference or over a recent time frame, such as 10 seconds, 30 seconds, 1 minute, 2 minutes, 5 minutes, etc.). Thus, the “least prominent portion” of the videoconference layout may refer to the portion of the videoconference layout that is least important to the participant viewing the videoconference layout, which may be based on portion position, whether the portion is in use, based on the participant (e.g., the participant's activity level) in the portion, etc.

After the second subset of participants has been displayed, the videoconference layout may then revert to display the first subset of the plurality of participants without displaying the second subset of the plurality of participants. Note that this may occur after all of the second subset of the participants has been displayed or when a subset of the second subset of participants have been displayed. For example, the method may return to displaying only the first subset of the plurality of participants in response to not receiving input for a predetermined period of time. As another example, the method may return to displaying the first subset of the plurality of participants after the user has seen all of the second subset of participants, e.g., after all the groups have been seen. Further, the method may return to displaying the first subset of the plurality of participants when the user provides input to return to that display, as desired.

### BRIEF DESCRIPTION OF THE DRAWINGS

A better understanding of the present invention may be obtained when the following detailed description is considered in conjunction with the following drawings, in which:

FIGS. 1 and 2 illustrate exemplary videoconferencing system participant locations, according to an embodiment;

FIGS. 3A and 3B illustrate exemplary conferencing systems coupled in different configurations, according to some embodiments;

FIG. 4 is a flowchart diagram illustrating an embodiment of a method for recording a videoconference; and

FIGS. 5A-5F and 6A-6D illustrate exemplary screen layouts for a videoconference, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.
U.S. patent application titled “Virtual Decoders”, Ser. No. 12/142,263, which was filed Jun. 19, 2008, whose inventors are Keith C. King and Wayne E. Mock, is hereby incorporated by reference in its entirety as though fully and completely set forth herein.
U.S. patent application titled “Video Conferencing System which Allows Endpoints to Perform Continuous Presence Layout Selection”, Ser. No. 12/142,302, whose inventors are Keith C. King and Wayne E. Mock, is hereby incorporated by reference in its entirety as though fully and completely set forth herein.
U.S. patent application titled “Video Conferencing Device which Performs Multi-way Conferencing”, Ser. No. 12/142,340, whose inventors are Keith C. King and Wayne E. Mock, is hereby incorporated by reference in its entirety as though fully and completely set forth herein.
U.S. patent application titled “Video Decoder which Processes Multiple Video Streams”, Ser. No. 12/142,377, whose inventors are Keith C. King and Wayne E. Mock, is hereby incorporated by reference in its entirety as though fully and completely set forth herein.
U.S. patent application titled “Virtual Multiway Scaler Compensation”, Ser. No. 12/171,358, whose inventors are Keith C. King and Wayne E. Mock, is hereby incorporated by reference in its entirety as though fully and completely set forth herein.
U.S. patent application titled “Virtual Distributed Multipoint Control Unit”, Ser. No. 12/712,947, whose inventors are Keith C. King, Ashish Goyal, and Hrishikesh Gopal Kulkarni, is hereby incorporated by reference in its entirety as though fully and completely set forth herein.

### Terms

The following is a glossary of terms used in the present application:

Memory Medium≧Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), smart phone, television system, grid computing system, or other device or combinations of devices. In general, the term “computer system” can be broadly defined to encompass any device (or combination of devices) having at least one processor that executes instructions from a memory medium.

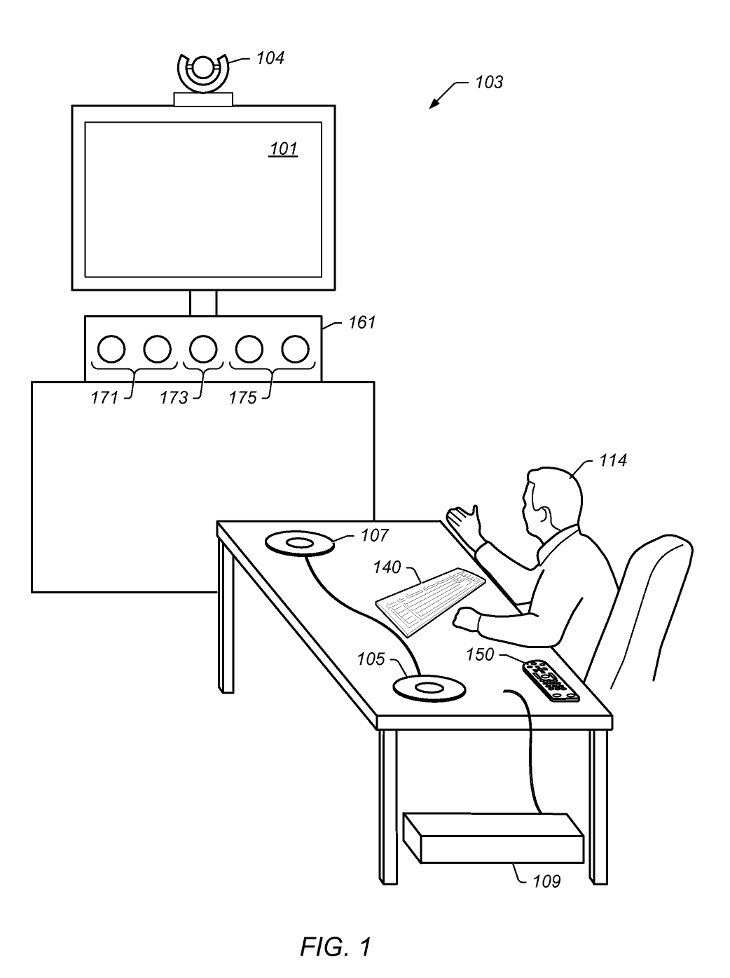

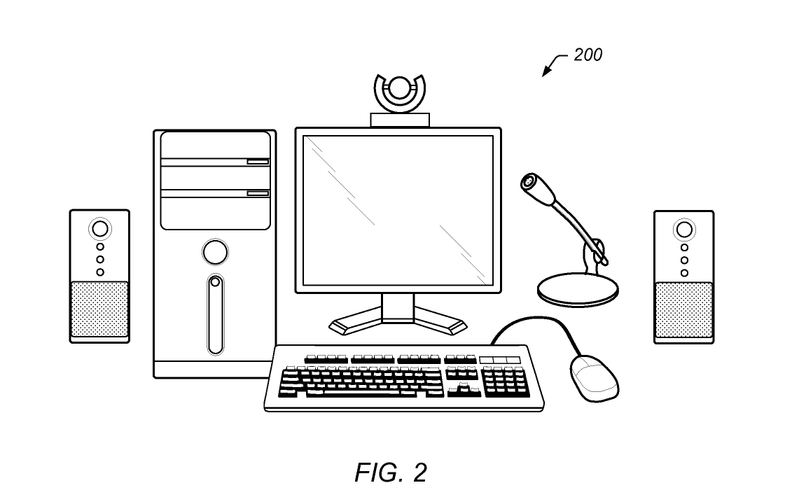

FIGS. 1 and 2—Exemplary Participant Locations

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference. In some embodiments, images acquired by the camera 104 may be encoded and transmitted to a multipoint control unit (MCU), which then provides the encoded stream to other participant locations (or videoconferencing endpoints)

The participant location may further include one or more input devices, such as the computer keyboard 140. In some embodiments, the one or more input devices may be used for the videoconferencing system 103 and/or may be used for one or more other computer systems at the participant location, as desired.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on the floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system, or to an MCU for provision to other conferencing systems. The conferencing system may be controlled by a participant or user through the user input components (e.g., buttons) on the speakerphones 105/107 and/or input devices such as the keyboard 140 and/or the remote control 150. Other system interfaces may also be used.

In various embodiments, the codec 109 may implement a real time transmission protocol. In some embodiments, the codec 109 (which may be short for “compressor/decompressor” or “coder/decoder”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may utilize MPEG, Indeo™, and Cinepak™, among others.

In some embodiments, the videoconferencing system 103 may be designed to operate with normal display or high definition (HD) display capabilities. The videoconferencing system 103 may operate with network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system 200 with a video camera, input devices, microphone and/or speakers such as the videoconferencing system of FIG. 2). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

Note that the videoconferencing system shown in FIGS. 1 and 2 may be modified to be an audioconferencing system. For example, the audioconference could be performed over a network, e.g., the Internet, using VOIP. The audioconferencing system, for example, may simply include speakerphones 105/107, although additional components may also be present. Additionally, note that any reference to a “conferencing system” or “conferencing systems” may refer to videoconferencing systems or audioconferencing systems (e.g., teleconferencing systems). In the embodiments described below, the conference is described as a videoconference, but note that the methods may be modified for utilization in an audioconference.

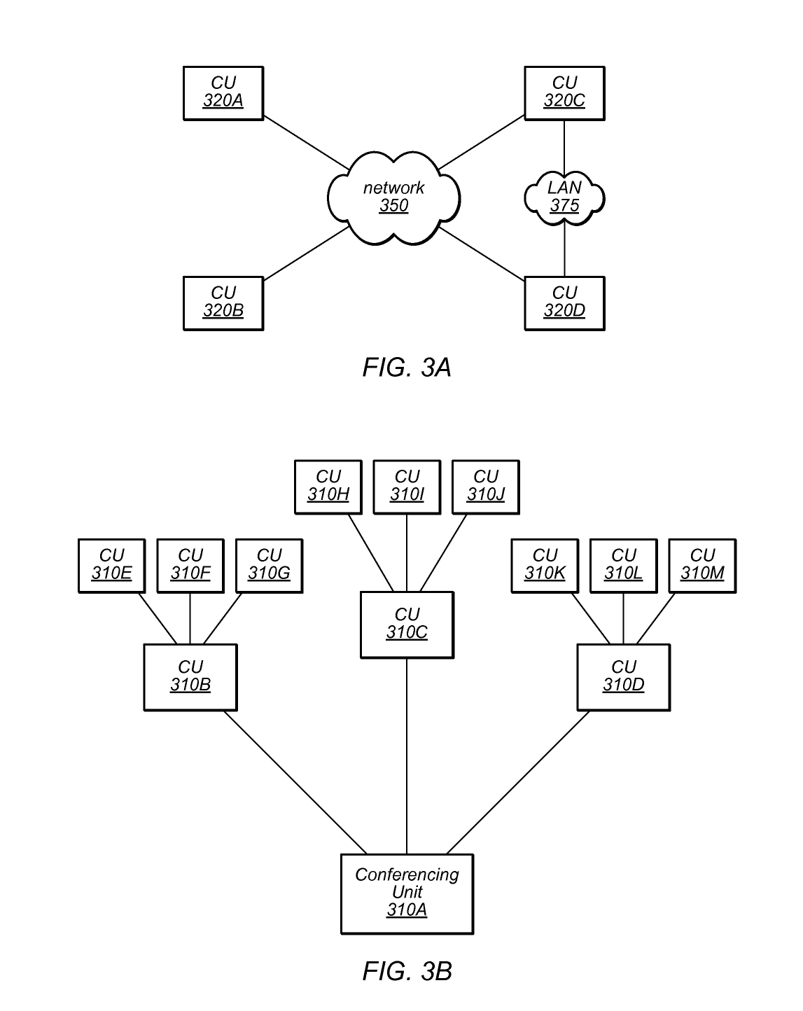

### FIGS. 3A and 3B—Coupled Conferencing Systems

FIGS. 3A and 3B illustrate different configurations of conferencing systems. The conferencing systems may be operable to perform the methods described herein. As shown in FIG. 3A, conferencing systems (CUs) 320A-D (e.g., videoconferencing systems 103 described above) may be connected via network 350 (e.g., a wide area network such as the Internet) and CU 320C and 320D may be coupled over a local area network (LAN) 375. The networks may be any type of network (e.g., wired or wireless) as desired.

FIG. 3B illustrates a relationship view of conferencing systems 310A-310M. As shown, conferencing system 310A may be aware of CU 310B-310D, each of which may be aware of further CU's (310E-310G, 310H-310J, and 310K-310M respectively). CU 310A may be operable to perform the methods described herein. In a similar manner, each of the other CUs shown in FIG. 3B, such as CU 310H, may be able to perform the methods described herein, as described in more detail below. Similar remarks apply to CUs 320A-D in FIG. 3A.

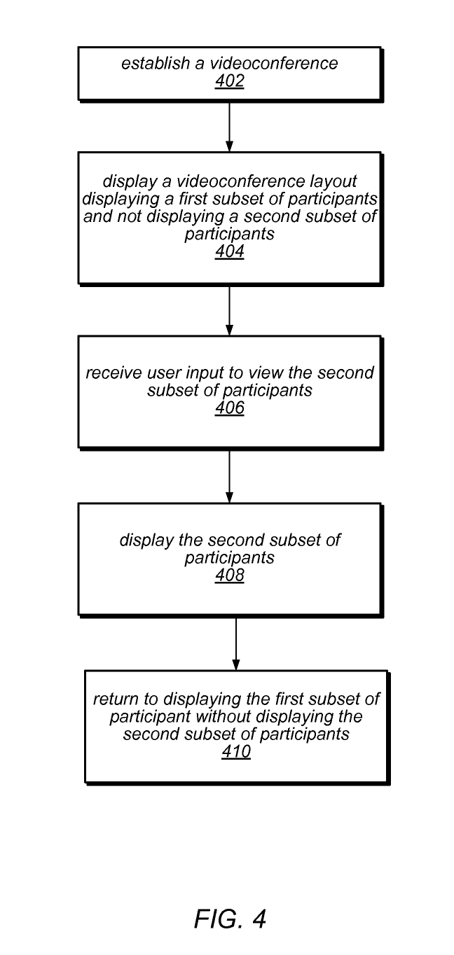

### FIG. 4—Displaying Unseen Participants in a Videoconference

FIG. 4 illustrates a method for displaying unseen participants in a videoconference. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a videoconference may be initiated or performed between a plurality of participants at respective participant locations. More specifically, the conference may be initiated between a first participant using a first endpoint (e.g., at a first participant location) and a plurality of other participants using other endpoints (e.g., at other participant locations). Thus, endpoints may be similar to those described above regarding FIGS. 1-3B, although other variations are envisioned. The videoconference may be established according to any of a variety of methods, e.g., the one described in patent application Ser. No. 11/252,238, which was incorporated by reference above. The videoconference may utilize an instant messaging service or videoconferencing service over the Internet, as desired. In some embodiments, a multipoint control unit (MCU) may perform the first videoconference between the plurality of videoconference endpoints. For example, one of the endpoints (e.g., the first endpoint) may act as the MCU and may perform decoding and encoding operations on video information transmitted in the first videoconference between the plurality of videoconferencing endpoints.

During the videoconference, in 404, each videoconferencing endpoint may provide a videoconference layout on a display of the videoconferencing endpoint. The videoconference layout may be selected by the participant or may be selected automatically (e.g., based on the number of participants or endpoints in the videoconference). For example, the participant(s) at a location may select a desired layout from a plurality of available layouts and/or the endpoint may automatically select a layout that is appropriate the number of participants.

The videoconference layout may include a plurality of different portions. Each portion of the videoconference layout may include one or more participants of the videoconference (e.g., at a respective other videoconference location). Thus, the videoconference layout may display a first subset of the plurality of participants. However, the videoconference layout may not include a second subset of the plurality of participants. Thus, a first participant at a first location may only view the first subset in the videoconference layout, but may not be able to view the second subset in the videoconference layout.

In some embodiments, the videoconference layout may include a first portion and a second portion. The first portion may be used to display images of a participant who is the current “active speaker” (e.g., the participant who is doing the majority of the current talking in the videoconference). Accordingly, the first portion may be referred to as the “active speaker” or “prominent” portion of the videoconference layout. However, it should be noted that the first portion may be used for other purposes than for the active speaker, as desired (in these cases, the method may still operate as described). The second portion may be used to display images of other participants in the videoconference (e.g., all or a subset of the remaining participants). The second portion may be referred to as the “continuous presence” portion of the videoconference layout. The “continuous presence” portion may allow the participant to view participants who are not the active speaker. This second portion may include a plurality of subportions, e.g., one for each other participant of the videoconference. Note that in the descriptions herein, the images of the participants being displayed in the layout may be referred to simply as ‘the participants being displayed in the layout’, i.e., the participants which the images are intended to represent; it should accordingly be understood that this usage does not refer to literal participants. Additionally, other types of layouts are envisioned which do not include active speaker portion(s).

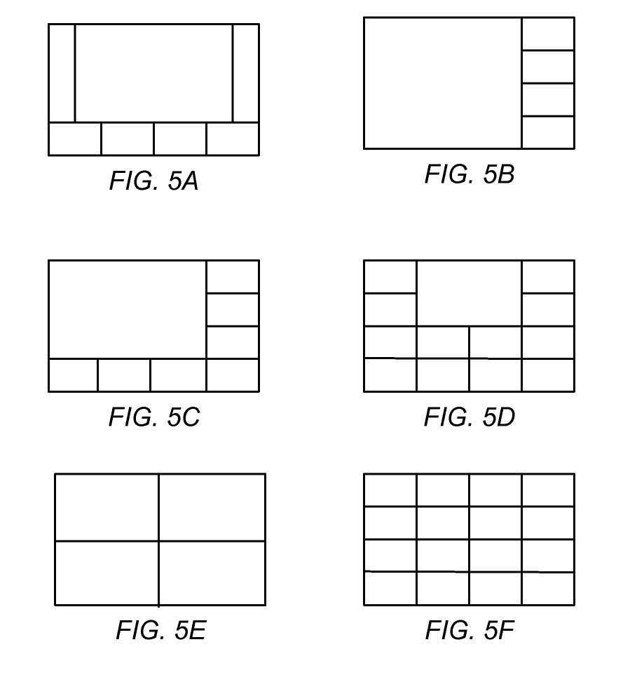

FIGS. 5A-5H illustrate various different videoconference layouts. As shown, FIG. 5A includes a prominent portion and four smaller portions along the bottom. FIG. 5B includes a prominent portion and four smaller portions along the right side. FIG. 5C includes a prominent portion and 7 smaller portions along the bottom and right side of the videoconference layout. FIG. 5D illustrates a prominent portion and 12 smaller portions surrounding the prominent portion on the left, right, and bottom sides. FIG. 5E illustrates an evenly divided layout with 4 portions and no prominent portion. FIG. 5F illustrates an evenly divided layout with 16 portions and no prominent portion.

In 406, user input to view the second subset of the plurality of participants may be received from the first participant. For example, the user input may be received to a user input device such as a remote control device, a keyboard, a mouse, an attached computer, etc. The user input may indicate that the participant wishes to view the unseen participants of the second subset. In one embodiment, the user input may be selected via a menu displayed on the videoconference display. Accordingly, the participant may select a “Who's in the Room” feature or menu item in order to view the second subset. In some embodiments, this selection may only be available while the participant is in certain mode(s), e.g., when a speaker mode is enabled.

In response to the user input, in 408, the second subset may be displayed in a first portion of the videoconference layout. For example, different groups of one or more participants of the second subset may be temporarily displayed in the first portion of the layout over a plurality of iterations. Thus, at a first time (e.g., in a first iteration), a first group of the second subset of participants may be displayed in the first portion. At a second time, a second group of the second subset of participants may be displayed in the first portion. As used herein “temporary display” of each of the groups of participants may refer to displaying the group for a long enough period of time that the viewing participant is able to identify or view each participant in the currently displayed group. It may be a length of time to allow for the viewing participant to judge the other participants' reaction to what is being discussed (or what was just discussed). This length of time may be as short as 1 or 2 seconds, but may also be longer, e.g., 5 seconds, 10 seconds, 30 seconds, etc.

Separate user input may be received for displaying each of the different groups. For example, the separate user input may be provided at each iteration to change from one group to another. In one embodiment, the participant may utilize a user input device, such as a remote, to provide the user input to change the currently displayed group of the second subset of participants. For example, the participant may press an up or down arrow (e.g., FECC buttons or 2 and 8 for DTMF buttons) to cycle to a previously displayed group or to the next group of unseen participants. Other buttons and user input methods are envisioned.

Alternatively, each different group may be displayed automatically without user input to change each displayed group. For example, the groups may be displayed periodically, e.g., on a timed interval, such as every 1 second, 2 seconds, 3 seconds, 5 seconds, 10 seconds, etc. In further embodiments, the time interval may correspond to the number of participants in the group. For example, a single participant may only be shown for 2 seconds while two participants may be shown for 3 or 4 seconds. As used herein “groups of participants” may refer to one or more participants, e.g., depending on how many are present at each different participant location.

The first portion of the videoconference layout may be a least prominent portion of the videoconference layout. For example, the least prominent portion may be a smaller portion of the videoconference layout. As another example, the least prominent portion may be in a corner of the videoconference layout (e.g., a top left or right corner). As indicated above, in some embodiments, the videoconference layout may have an “active speaker portion” and a “continuous presence portion”. In layouts including these two types of portions, the least prominent portion may be in the continuous presence portion (e.g., in one of the subportions of the continuous presence portion). In one embodiment, a participant in a subportion of the continuous presence portion may be promoted to the active speaker portion. Accordingly, in embodiments where that subportion is no longer used, it may be used for displaying the unseen participants of the videoconference. Thus, that subportion may be the “least prominent portion” of the videoconference layout. In another embodiment, the “least prominent portion” of the videoconference layout may be the portion of the videoconference that is used for a participant who is currently being displayed but has spoken the least in the videoconference (e.g., over the whole of the videoconference or over a recent time frame, such as 10 seconds, 30 seconds, 1 minute, 2 minutes, 5 minutes, etc.). Thus, the “least prominent portion” of the videoconference layout may refer to the portion of the videoconference layout that is least important to the participant viewing the videoconference layout, which may be based on portion position, whether the portion is in use, or based on the participant (e.g., the participant's activity level) in the portion.

In 410, after the second subset of participants has been displayed, the videoconference layout may continue to display the first subset of the plurality of participants without displaying the second subset of the plurality of participants. Note that this may occur after all of the second subset of the participants have been displayed or when a subset of the second subset of participants have been displayed. For example, the method may return to displaying only the first subset of the plurality of participants in response to not receiving input for a predetermined period of time. As another example, the method may return to displaying the first subset of the plurality of participants after the user has seen all of the second subset of participants, e.g., after all the groups have been seen. Further, the method may return to displaying the first subset of the plurality of participants when the user provides input to return to that display, as desired.

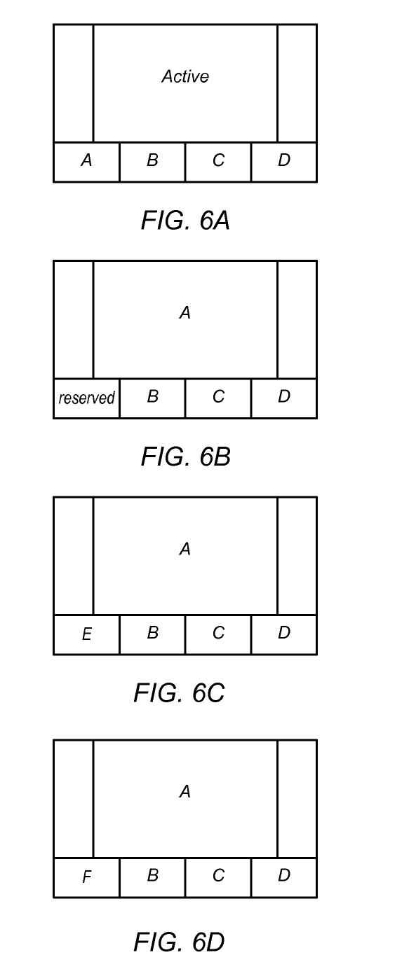

FIGS. 6A-6D illustrate one embodiment of the method described above. FIG. 6A illustrates an exemplary videoconference layout that includes an active speaker portion and four subportions of a continuous presence portion. The videoconference may include seven different participants, each at different participant locations (A, B, C, D, E, F, and the location of the participant viewing the layout). In this example, participants A, B, C, and D are shown in FIG. 6A. In FIG. 6B, participant A is promoted to the active speaker portion. In this embodiment, his prior sub-portion remains reserved for the participant A, for when participant A is no longer the active speaker. If the participant viewing the layout invokes the method described above, the least prominent portion may be identified to be the reserved portion previously inhabited by participant A. Accordingly, as shown in FIG. 6B, the participant may see previously unseen participant E in that location. Then, after providing user input, or in response to an automatic change, depending on the embodiment, in FIG. 6C, the participant may view previously unseen participant F. After viewing these other participants, the layout may revert back to FIG. 6B, as desired.

Embodiments of a subset or all (and portions or all) of the above may be implemented by program instructions stored in a memory medium or carrier medium and executed by a processor.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A non-transitory memory medium comprising program instructions for displaying participants in a videoconference at a first videoconference endpoint, wherein the program instructions are executable to:
display a videoconference layout comprising a plurality of portions, wherein each portion of the videoconference layout comprises one or more participants of the videoconference, wherein a plurality of the participants of the videoconference are not currently displayed in the videoconference layout;
receive user input to view the plurality of the participants who are not currently displayed in the videoconference layout; and
in response to the user input, display the plurality of the participants in a first portion of the videoconference layout.

2. The non-transitory memory medium of claim 1, wherein said displaying the plurality of the participants in the videoconference comprises displaying a first subset of the plurality of participants in a first portion of the videoconference layout at a first time and displaying a second subset of the plurality of participants in the first portion at a second time.

3. The non-transitory memory medium of claim 2, wherein the program instructions are executable to:
receive user input to view the second subset of the plurality of participants;
wherein said displaying the second subset of the plurality of participants in the first portion at the second time is performed in response to the user input to view the second subset of the plurality of participants.

4. The non-transitory memory medium of claim 2, wherein changing from displaying the first subset at the first time to displaying the second subset at the second time is performed automatically, without user input requesting the change.

5. The non-transitory memory medium of claim 1, wherein said displaying the plurality of participants in the videoconference layout is performed in a least prominent portion of the videoconference layout.

6. The non-transitory memory medium of claim 5, wherein a first participant is displayed in an active speaker portion of the videoconference layout, wherein the least prominent portion of the videoconference layout comprises a portion of the videoconference layout that the first participant was in before being promoted to the active speaker portion of the videoconference layout.

7. The non-transitory memory medium of claim 5, wherein the least prominent portion of the videoconference layout corresponds to a portion displaying a participant who has spoken the least in the videoconference over a period of time.

8. The non-transitory memory medium of claim 5, wherein said displaying the plurality of participants in the videoconference layout is performed within a continuous presence portion of the videoconference layout.

9. The non-transitory memory medium of claim 1, wherein the program instructions are further executable to:
after said displaying the plurality of participants, continue display of the one or more participants without displaying the plurality of participants.

10. The non-transitory memory medium of claim 1, wherein the program instructions are further executable to:
automatically return to display of only the one or more participants in response to not receiving user input for a predetermined amount of time.

11. A method for displaying participants in a videoconference at a first videoconference endpoint, wherein the videoconference is being conducted among a plurality of participants, the method comprising:
displaying a videoconference layout comprising a first subset of the plurality of participants, wherein the first subset is less than all of the plurality of participants, wherein a second subset of the plurality of the participants of the videoconference are not currently displayed in the videoconference layout;
receiving user input to view the second subset of the plurality of the participants who are not currently displayed in the videoconference layout; and
in response to the user input, temporarily displaying different groups of one or more of the participants of the second subset in a first portion of the layout for a plurality of iterations.

12. The method of claim 11, wherein separate user input is received for displaying each of the different groups of the one or more of the participants of the second subset

13. The method of claim 11, wherein separate user input is received for each iteration of displaying different groups of the one or more of the participants of the second subset.

14. The method of claim 11, wherein said temporarily displaying the different groups is performed automatically without user input to change from one group to another.

15. The method of claim 11, further comprising:
after said displaying different groups of one or more of the participants of the second subset in a first portion of the layout for a plurality of iterations, continuing display of the first subset of the plurality of participants, wherein the second subset of the plurality of the participants of the videoconference are not displayed in the videoconference layout.

16. The method of claim 11, wherein said temporarily displaying different groups of one or more of the participants of the second subset in the first portion of the layout for a plurality of iterations comprises temporarily displaying different groups of the one or more of the participants for all of the participants of the second subset.

17. The method of claim 11, further comprising:
automatically returning to display of only the first subset of the plurality of participants in response to not receiving user input for a predetermined amount of time.

18. The method of claim 11, wherein the first portion is a least prominent portion of the videoconference layout.

19. The method of claim 18, wherein a first participant is displayed in an active speaker portion of the videoconference layout, wherein the least prominent portion of the videoconference layout comprises a portion of the videoconference layout that the first participant was in before being promoted to the active speaker portion of the videoconference layout.

20. The method of claim 18, wherein the least prominent portion of the videoconference layout corresponds to a portion displaying a participant who has spoken the least in the videoconference.

21. A videoconference endpoint, comprising:
a codec;
a display coupled to the codec;
a user input device coupled to the codec;
wherein the codec is configured to:
display a videoconference layout comprising a plurality of portions on the display, wherein each portion of the videoconference layout comprises one or more participants of the videoconference, wherein a plurality of the participants of the videoconference are not currently displayed in the videoconference layout;
receive user input to view the plurality of the participants who are not currently displayed in the videoconference layout via the user input device; and
in response to the user input, display the plurality of the participants in a first portion of the videoconference layout on the display.
